(19) United States
(12) Patent Application Publication
(10) Pub. No.: US 2024/0253472 A1
(43) Pub. Date: Aug. 1, 2024

(54) ELECTRIC VEHICLE AND A METHOD FOR CONTROLLING A DRIVETRAIN OF ELECTRIC VEHICLE

(71) Applicant: Honda Motor Co., Ltd., Tokyo (JP)

(72) Inventor: Joel D. Torgison, Columbus, OH (US)

(21) Appl. No.: 18/162,431

(22) Filed: Jan. 31, 2023

(51) Int. Cl. B60L 15/20; B60L 3/10; B60L 50/60

(52) U.S. Cl. CPC B60L 15/20; B60L 3/106; B60L 50/60; B60L 2240/12; B60L 2240/423; B60L 2240/465; B60L 2240/642; B60L 2250/28; B60L 2260/20

(57) ABSTRACT

A method for controlling an electric vehicle includes activating a drive force control strategy in response to a vehicle speed being below a speed limit and an angle of inclination of a road on which the electric vehicle is travelling being above a threshold angle. The method also includes determining a wheel slip of the at least one wheel when the drive force control strategy is active. The method further includes controlling an output torque of the at least one electric motor based on the determined wheel slip during an increase of the output torque to a requested value to facilitate a movement of the electric vehicle on the road. A torque coefficient used by the controller to control the output torque is selected based on at least one of a drive mode of the electric vehicle or the angle of inclination.

### BACKGROUND

The disclosed subject matter relates generally to an electric vehicle. More particularly, the disclosed subject matter relates a method and a control system for controlling a drive force for a battery powered electric vehicle at an inclined road.

For climbing on an inclined road, such as, a hill, from a stationary condition, a drivetrain of the vehicle needs to provide an optimum drive force to the wheels of the vehicle. A relatively larger drive force generally results into wheel slip, while the vehicle does not climb the hill if a less than the optimum drive force is provided. Historically, the internal combustion engine-based drivetrains may be difficult to control and struggle to provide optimum drive force in low speed take off conditions due to torque convertor slip variation, intake filling delays, limited torque delivery based on output, and other factors, etc., which may be undesirable.

### SUMMARY

In accordance with one embodiment of the present disclosure, a method for controlling an electric vehicle is provided. The electric vehicle has at least one electric motor operatively coupled to at least one wheel of the electric vehicle to rotate the at least one wheel. The method includes activating, by a controller, a drive force control strategy in response to a vehicle speed being below a speed limit and an angle of inclination of a road on which the electric vehicle is travelling being above a threshold angle. The method also includes determining, by the controller, a wheel slip of the at least one wheel when the drive force control strategy is active. The method further includes controlling, by the controller, an output torque of the at least one electric motor based on the determined wheel slip during an increase of the output torque to a requested value to facilitate a movement of the electric vehicle on the road. A torque coefficient used by the controller to control the output torque is selected based on at least one of a drive mode of the electric vehicle or the angle of inclination.

In accordance with another embodiment of the present disclosure, a drivetrain for an electric vehicle is provided. The electric vehicle includes a power storage unit. The drivetrain includes a plurality of wheels configured to facilitate a movement of the electric vehicle over a road, and at least one electric motor electrically coupled to the power storage unit and operatively coupled to at least one wheel of the plurality of wheels to drive the at least one wheel. The drivetrain further includes a controller communicatively coupled to the at least one electric motor. The controller is configured to activate a drive force control strategy in response to a vehicle speed being below a speed limit and an angle of inclination of the road on which the electric vehicle is travelling being above a threshold angle. The controller is further configured to determine a wheel slip of the at least one wheel when the drive force control strategy is active. Moreover, the controller is configured to control an output torque of the at least one electric motor based on the determined wheel slip during an increase of the output torque to a requested value to facilitate a movement of the electric vehicle on the road. A torque coefficient used by the controller to control the output torque is selected based on at least one of a drive mode of the electric vehicle or the angle of inclination.

In accordance with yet a further embodiment of the present disclosure an electric vehicle is disclosed. The electric vehicle includes a power storage unit to store electrical power, and a plurality of wheels configured to facilitate a movement of the electric vehicle over a road. The electric vehicle also includes at least one electric motor electrically coupled to the power storage unit and operatively coupled to at least one wheel of the plurality of wheels to drive the at least one wheel, and a controller communicatively coupled to the at least one electric motor. The controller is configured to activate a drive force control strategy in response to a vehicle speed being below a speed limit and an angle of inclination of the road on which the electric vehicle is travelling being above a threshold angle. The controller is also configured to determine a wheel slip of the at least one wheel when the drive force control strategy is active. Moreover, the controller is configured to control an output torque of the at least one electric motor based on the determined wheel slip during an increase of the output torque to a requested value to facilitate a movement of the electric vehicle on the road. A torque coefficient used by the controller to control the output torque is selected based on at least one of a drive mode of the electric vehicle or the angle of inclination.

### BRIEF DESCRIPTION OF THE DRAWINGS

Certain embodiments of the present disclosure will be better understood from the following description taken in conjunction with the accompanying drawings in which:

FIG. 1 is a schematic view of an electric vehicle depicting a drivetrain of the electric vehicle, in accordance with one embodiment of the present disclosure; and

FIG. 2 illustrates a schematic view of a system of the battery powered vehicle having a sensing system in communication with a controller, in accordance with one embodiment of the present disclosure.

### DETAILED DESCRIPTION OF EXEMPLARY EMBODIMENTS

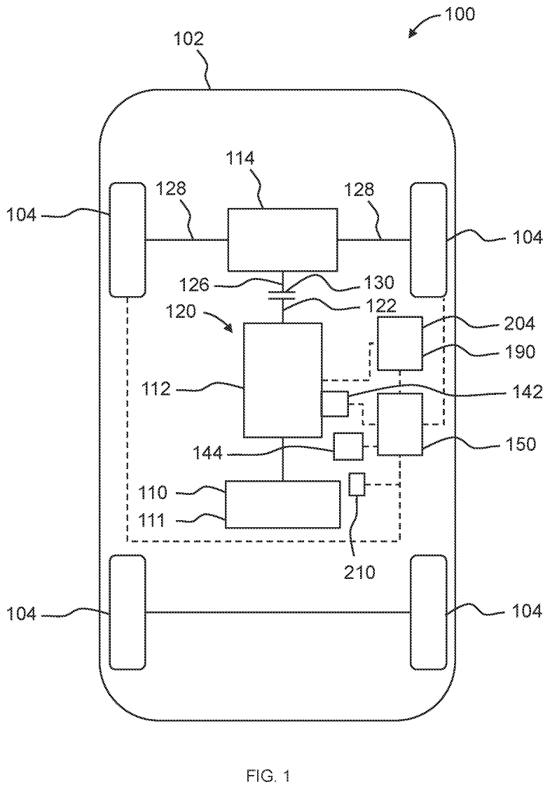

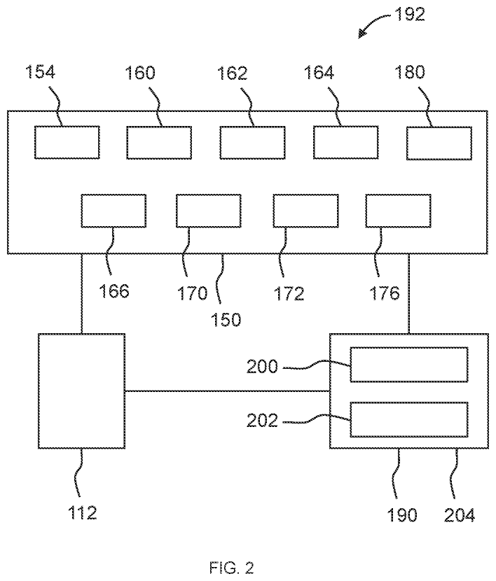

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-2, wherein like numbers indicate the same or corresponding elements throughout the views.

FIG. 1 illustrates an electric vehicle 100 (hereinafter referred to as vehicle 100), in accordance with one embodiment of the disclosure. As shown, the vehicle 100 includes a vehicle body 102 and a plurality of traction members, for example wheels 104, supporting the vehicle body 102 on a surface. Further, the vehicle 100 includes a power storage unit 110, such as, at least one battery 111, providing power to propel the vehicle 100 over the road/surface and auxiliary systems of the vehicle 100. Although the battery 111 is contemplated as the power storage unit 110, it may be appreciated that a capacitor, a supercapacitor or any other power storage unit suitable for storing an electric power can also be utilized. Further, the vehicle 100 may include at least one electric motor 112, and a transmission 114. The vehicle is driven/propelled by a drivetrain 120 including the power storage unit 110, the transmission 114, and the at least one electric motor 112 connected to the power storage unit 110 to convert the electric power received from the power storage unit 110 to a rotational kinetic energy and operatively connected to the one or more wheels 104 to rotate the wheels 104 and propel the vehicle 100 over the road.

FIG. 1 shows a schematic illustration of the drivetrain 120 of the vehicle 100 from the power storage unit 110 to the wheels 104. The electric motor 112 may include a motor output shaft 122, while the transmission 114 includes a transmission input shaft 126 at an input end and at least one transmission output shaft 128, for example, two output shafts 128 at an output end. The transmission output shafts 128 may in turn be operatively connected to and propels the wheels 104. Further, the drivetrain 120 may include a clutch 130 to selectively disengage the motor output shaft 122 from the transmission input shaft 126. The clutch 130 facilitates a disengagement of the motor output shaft 122 from the transmission input shaft 126 in response a pressing or a displacement of a clutch lever (not shown) from a free position.

Moreover, the vehicle 100 may include a plurality of driver input devices to facilitate a driver to control the movement of the vehicle 100 along with other operations of the vehicle 100. The controlled operations can include speed control, braking, steering, drive mode control, and the like. The operator input devices may include an accelerator pedal 142 (shown in FIG. 1) for controlling a speed of the motor output shaft 122, the clutch lever, one or more gear shift levers, and a drive mode selector 144, and the like. The drive mode selector 144 enables a selection one of the plurality of drive modes in which the vehicle 100 may be operated. In an embodiment, plurality of drive modes includes an economy mode, a normal mode, a sand mode, a dirt mode, a trailer towing mode, a snow mode, a trail mode, and a sport mode. It may be appreciated that each of the drive modes include separate operating characteristics, for example, speed vs torque curve, to enable a desired performance of the vehicle 100 in the selected drive mode. For example, upon selection of the economy mode, the at least one electric motor 112 is operated/controlled to provide maximum efficiency i.e., the vehicle 100 provides increased mileage for the charge stored inside the at least one battery 111. Similarly, in the sports mode, the at least one electric motor 112 is controlled so as to provide maximum operating power.

The vehicle 100 also collects and records operational data relating to the operation of the vehicle 100 as it traverses the surface. The vehicle 100 may include a variety of sensors operating independently or as components of other control and monitoring systems to automatically monitor various operational data during travel of the vehicle 100 over the surface. Some operational data may be monitored directly, while other data may be derived or calculated from the monitored parameters. Referring to FIG. 2, a sensing unit 150 for detecting at least one operating parameters of the vehicle 100 during a travel of the vehicle 100 is shown. In an embodiment, the sensing unit 150 has a plurality of sensors associated with the operator input devices to detect manipulation of the operator input devices by a driver/operator/user of the vehicle. In an exemplary embodiment, the sensing unit 150 may include an accelerator pedal position sensor 154 operatively connected to the accelerator pedal 142 to detect a displacement of the accelerator pedal 142 from a free position of the accelerator pedal 142.

The sensing unit 150 may include various sensors monitoring the operational data, for example, speed sensors detecting vehicle, electric motor, transmission speeds, and torque sensors sensing torque at various points along the drivetrain and/or rolling resistance of the wheels 104. In an embodiment, the sensing unit 150 may include a motor output speed sensor 160 for monitoring/detecting a rotational speed of the motor output shaft 122, a transmission input speed sensor 162 for monitoring/detecting a rotational speed of the transmission input shaft 126, and at least one transmission output speed sensor 164 for monitoring/detecting a rotational speed of the transmission output shaft 128. Also, the sensing unit 150 includes at least one wheel speed sensor 166 to determine a rotational speed of the at least one wheel 104. Moreover, the sensing unit 150 may include a vehicle speed sensor 170 to detect/determine a speed of travel of the vehicle 100 over the surface. In an embodiment, the sensing unit 150 may also include an inclination sensor 172 for detecting an angle of inclination of the of the surface/road on which the vehicle 100 is travelling. In some implementation, the sensing unit 150 may include a current sensor 176 to determine/detect/measure a current drawn by the electric motor 112 from the power storage unit 110. In some embodiments, the sensing unit may include a drive mode selector position sensor 180 to detect a position of the drive mode selector 144 to determine a drive mode of the vehicle 100.

The operator input devices, for example, the pedal 142, the selector 144, a controller 190 (ECM), and the sensing unit 150 are components of a drive control system for the vehicle 100. The controller 190 is operatively connected to the sensing unit 150, the at least one electric motor 112, and various other components and systems of the vehicle 100. Referring to FIG. 2, an exemplary arrangement of electrical and control components of the drivetrain of the vehicle 100 is shown with various control components integrated into a drivetrain control system 192. The controller 190 may be configured to process the information received from the operator input devices, such as the accelerator pedal 142, the drive mode selector 144, and various sensors of the sensing unit 150, such as, the accelerator pedal position sensor 154, and the drive mode selector position sensor 180, the inclination sensor 172, the at wheel speed sensor 166, the vehicle speed sensor 170, etc., and outputting command and control signals to the at least one electric motor, the transmission 114, and various actuators of the vehicle 100.

The controller 190 may include a processor 200 for executing specified instructions, which controls and monitors various functions associated with the vehicle 100. The processor 200 may be operatively connected to a memory 202 for storing instructions related to the control of the vehicle 100 and vehicle components. The memory 202 as illustrated is integrated into the controller 190, but those skilled in the art will understand that the memory 202 may be separate from the controller 190 but onboard the vehicle 100, and/or remote from the controller 190 and the vehicle 100, while still being associated with and accessible by the controller 190 to store information in and retrieve information from the memory 202 as necessary during the operation of the vehicle 100. Although the processor 200 is shown, it is also possible and contemplated to use other electronic components such as a microcontroller, an application specific integrated circuit (ASIC) chip, or any other integrated circuit device. While the discussion provided herein relates to the functionality of a drive control system, the controller 190 may be configured to control other aspects of the operation of the vehicle 100. Moreover, the controller 190 may refer collectively to multiple control and processing devices across which the functionality of the drive control system and other systems of the vehicle 100 may be distributed. For example, the at least one electric motor 112, the drive train, and the retarding system may each have one or more controllers that communicate with the controller 190. Such variations in consolidating and distributing the processing of the controller 190 as described herein are contemplated as having use in braking reduction and transmission control in accordance with the present disclosure.

The sensors are operatively connected to the controller 190 to transmit sensor signals that may be used by the controller 190 to control the corresponding components or systems of the vehicle 100, such as the at least one electric motor 112, or to perform further processing related to the operation and control of other components of the vehicle 100. For example, the controller 190 is configured to determine a wheel slip based on the sensor signals from the at least wheel speed sensor 166 and the vehicle speed sensor 170. Bases on the determined wheel slip, the controller 190 is configured to perform a control operation of the at least one electric motor 112 as discussed below. Further, the controller 190 is configured to determine an angle of inclination of the surface/path/road on which the vehicle 100 is travelling or positioned based on input from the inclination sensor 172, and activates or deactivates a drive force control strategy (i.e., electric motor control strategy) based on the determined angle of inclination. For example, the controller 190 is configured to activate the drive force control strategy when the determined angle of inclination is above a threshold angle. Accordingly, the drive force control strategy is deactivated or remains deactivated when the angle of inclination is below the threshold value. In addition to the angle of inclination, the controller 190 may determine a vehicle speed based on input from the vehicle speed sensor 170, and activates the drive force control strategy only when the vehicle speed is below a speed limit. Accordingly, the controller 190 is configured to deactivate the drive force control strategy when the vehicle speed crosses the speed limit. In this manner, the controller 190 activates the drive force control strategy when the angle of inclination is above the threshold value and the vehicle speed is below the speed limit.

In some alternative or optional embodiments, the controller 190 is configured to determine the drive mode of the vehicle 100 before activating the drive force control strategy. In some embodiments, as discussed above, the vehicle 100 may be driven in the plurality of operating modes, for example, the normal mode, the sand mode, the dirt mode, the trailer towing mode, the snow mode, the trail mode, the sports mode, the economy mode, etc. In such a case, the controller 190 is configured to activates the drive force control strategy when the drive mode corresponds to one or more of the drive modes, for example, the sports mode, in addition to the vehicle speed being below the speed limit and the angle of inclination being above than the threshold angle. In some example embodiment, the controller 190 may be configured to activate the drive force control strategy when the drive mode corresponds to the normal mode.

Upon activation of the drive force control strategy, the controller 190 is configured to monitor the wheel slip (i.e., tire slip) for one or more of the wheels 104, for example, drive wheels, and controls the at least one electric motor 112 based on the detected wheel slip. In an embodiment, the controller 190 is configured to control an output torque or power output of the at least one electric motor 112 based on the tire/wheel slip. For example, in an embodiment, the controller 190 is configured to control the at least one electric motor 112 when the wheel slip above a target slip. In an embodiment, the controller 190 is a PID controller 204 and is configured to reduce the torque output i.e., the drive force of the at least one electric motor 112 when the determined tire slip is above the target slip. Upon reducing the torque output or drive force corresponding to the deviation of the determined slip and the target slip, the controller 190 may again check the actual wheel slip and increase the output torque. Before increasing the output torque, the controller may wait for a predetermined time and increases the output torque or the drive force if the detected slip remains below the target slip for a predetermined time duration. The controller 190 may wait for the predetermined time duration before increasing or decreasing the torque output or the drive force provided by the at least one electric motor 112 to prevent a fluctuation of the output torque of the at least one electric motor 112.

Upon increasing the output torque, the controller 190 may again check the tire/wheel slip and compare the determined tire slip to the target slip, and accordingly controls the output torque of the at least one electric motor 112. In this manner, the controller 190 is configured to iteratively reduce the tire slip to a value below or equal to the target slip and quickly increase the drive force or output torque to the driver requested torque to create an optimal condition for hill climb. The requested torque corresponds to a displacement of the accelerator pedal 142 from its free position. In some embodiments, the controller 190 includes a plurality of PID coefficients to control one or more parameters of the at least one electric motor 112 to control the output torque to control/reduce the wheel slip to a level equal to or above the tire slip so that drive requested torque is achieved quickly. In an embodiment, the controller 190 selects a PID coefficient out of the plurality of PID coefficients based on an angle of inclination and/or the drive mode of the vehicle 100. Accordingly, the controller 190 may utilize one PID coefficient when the angle of inclination is between a first range, and may utilize other PID coefficient when the angle of inclination is between a different range. Similarly, the controller 190 may utilize one PID coefficient when the drive mode is a first drive mode, for example, the sports mode, and may utilize another PID coefficient when the drive is another drive mode, for example, normal mode. Also, the controller 190 may utilize the different PID coefficients for different combinations of the angle of inclinations with the drive modes.

In some optional embodiments, the vehicle 100 may include a selector switch 210 to enable the activation and deactivation of the drive force control strategy. The selector switch 210 may be configured to be displaced between a first position that corresponds to the activation of the drive force control strategy and a second position that corresponds to the deactivation of the drive force control strategy. It may be appreciated that the selector switch 210 is displaced between the first position and the second position manually by a driver. Accordingly, the controller 190 may determine the position of the selector switch 210 and activates or deactivates the drive force control strategy. Accordingly, in addition to the drive mode, the vehicle speed, and the inclination angle, the controller 190 is configured to activate the drive force control strategy when the selector switch is at the first position. Therefore, the controller 190 may keep the drive force control strategy deactivated or deactivates the drive force control strategy when the selector switch 210 is at the second position irrespective of the vehicle speed, the inclination angle, and the drive mode.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A method for controlling an electric vehicle having at least one electric motor operatively coupled to at least one wheel of the electric vehicle to rotate the at least one wheel, the method comprising:
activating, by a controller, a drive force control strategy in response to a vehicle speed being below a speed limit and an angle of inclination of a road on which the electric vehicle is travelling being above a threshold angle;
determining, by the controller, a wheel slip of the at least one wheel when the drive force control strategy is active; and
controlling, by the controller, an output torque of the at least one electric motor based on the determined wheel slip during an increase of the output torque to a requested value to facilitate a movement of the electric vehicle on the road, wherein a torque coefficient used by the controller to control the output torque is selected based on at least one of a drive mode of the electric vehicle or the angle of inclination.

2. The method of claim 1, wherein the output torque of the at least one electric motor is controlled to keep the determined wheel slip below or equal to a target slip.

3. The method of claim 1, wherein activating the drive force control strategy includes
determining a drive mode of the electric vehicle, and
activating the drive force control strategy based on the drive mode of the electric vehicle.

4. The method of claim 1, wherein the wheel slip of the at least one wheel is determined based on a speed of the at least one wheel and the vehicle speed.

5. The method of claim 1, further including determining the requested torque based on a displacement of an accelerator pedal of the electric vehicle from a free position of the accelerator pedal.

6. The method of claim 1, wherein the torque coefficient is selected from a plurality of PID coefficients.

7. A drivetrain for an electric vehicle including a power storage unit, the drivetrain comprising:
a plurality of wheels configured to facilitate a movement of the electric vehicle over a road;
at least one electric motor electrically coupled to the power storage unit and operatively coupled to at least one wheel of the plurality of wheels to drive the at least one wheel; and
a controller communicatively coupled to the at least one electric motor and configured to
activate a drive force control strategy in response to a vehicle speed being below a speed limit and an angle of inclination of the road on which the electric vehicle is travelling being above a threshold angle,
determine a wheel slip of the at least one wheel when the drive force control strategy is active, and
control an output torque of the at least one electric motor based on the determined wheel slip during an increase of the output torque to a requested value to facilitate a movement of the electric vehicle on the road, wherein a torque coefficient used by the controller to control the output torque is selected based on at least one of a drive mode of the electric vehicle or the angle of inclination.

8. The drivetrain of claim 1, wherein the output torque of the at least one electric motor is controlled to keep the determined the wheel slip below or equal to a target slip.

9. The drivetrain of claim 1, wherein the controller is configured to
determine a drive mode of the electric vehicle, and
activate the drive force control strategy based on the drive mode of the electric vehicle.

10. The drivetrain of claim 1, wherein the wheel slip of the at least one wheel is determined based on a speed of the at least one wheel and the vehicle speed.

11. The drivetrain of claim 1, wherein the controller is configured to determine the requested torque based on a displacement of an accelerator pedal of the electric vehicle from a free position of the accelerator pedal.

12. The drivetrain of claim 1, wherein the torque coefficient is selected from a plurality of PID coefficients.

13. An electric vehicle, comprising:
a power storage unit to store electrical power;
a plurality of wheels configured to facilitate a movement of the electric vehicle over a road;
at least one electric motor electrically coupled to the power storage unit and operatively coupled to at least one wheel of the plurality of wheels to drive the at least one wheel; and
a controller communicatively coupled to the at least one electric motor and configured to
activate a drive force control strategy in response to a vehicle speed being below a speed limit and an angle of inclination of the road on which the electric vehicle is travelling being above a threshold angle,
determine a wheel slip of the at least one wheel when the drive force control strategy is active, and
control an output torque of at least one electric motor based on the determined wheel slip during an increase of the output torque to a requested value to facilitate a movement of the electric vehicle on the road, wherein a torque coefficient used by the controller to control the output torque is selected based on at least one of a drive mode of the electric vehicle or the angle of inclination.

14. The electric vehicle of claim 13, further including an inclination sensor to determine the angle of inclination of the road.

15. The electric vehicle of claim 13, further including a vehicle speed sensor to determine the vehicle speed.

16. The electric vehicle of claim 13, wherein the output torque of the at least one electric motor is controlled to keep the determined wheel slip below or equal to a target slip.

17. The electric vehicle of claim 13, wherein the controller is configured to
determine a drive mode of the electric vehicle, and
activate the drive force control strategy based on the drive mode of the electric vehicle.

18. The electric vehicle of claim 13, wherein the wheel slip of the at least one wheel is determined based on a speed of the at least one wheel and the vehicle speed.

19. The electric vehicle of claim 13, further including
an accelerator pedal adapted to be displaced by a driver of the electric vehicle, and
the controller is configured to determine the requested torque based on a displacement of the accelerator pedal from a free position of the accelerator pedal.

20. The electric vehicle of claim 13, wherein the torque coefficient is selected from a plurality of PID coefficients.
